(19) United States
(12) Patent Application Publication
(10) Pub. No.: US 2025/0229957 A1
(43) Pub. Date: Jul. 17, 2025

(54) LIQUID DISPENSING DEVICE AND METHOD THEREOF

(71) Applicant: HCL Technologies Limited, New Delhi (IN)

(72) Inventors: Karthikeyan Sabapathy, Bangalore (IN); Vijaya Pratap V N, Bangalore (IN)

(21) Appl. No.: 19/006,474

(22) Filed: Dec. 31, 2024

(30) Foreign Application Priority Data
Jan. 15, 2024 (IN) 202411002930

(51) Int. Cl. B65D 47/20; B65D 25/02

(52) U.S. Cl. CPC B65D 47/20; B65D 25/02

(57) ABSTRACT

The invention relates to a liquid dispensing device. The liquid dispensing device includes an air column configured to provide stability to the liquid dispensing device. The liquid dispensing device further includes a set of two side walls affixed to opposite sides of the air column to create a casing, and a bottom wall coupled to the casing. The bottom wall further includes an opening configured to dispense a predefined amount of the liquid. Further, the liquid dispensing device includes a cap attached to the bottom wall. The cap further includes a hollow section configured to collect the predefined amount of the liquid to be dispensed from the opening.

### TECHNICAL FIELD

This invention generally relates to packaging. More specifically, the invention relates to a liquid dispensing device and method of dispensing liquid from a liquid dispensing device.

### BACKGROUND

Today, approximately 400 million tons of plastic waste is generated every year, with 36% attributed to plastic packaging waste. The plastic packaging includes a wide variety of plastics, broadly categorized as rigid and flexible. In the context of liquid product packaging, rigid plastic packaging, which includes cans and containers that are resistant to shape deformation, inherently demands more substantial material volume than its flexible counterpart. The rigid plastic packaging often includes features like caps, closures, and dispensing mechanisms, offering precise dosing and user-friendly handling. It excels in product protection, safeguarding against impact, breakage, contamination, and tampering. Additionally, the rigid plastic packaging serves as an optimal canvas for branding, offering an ideal surface for labels, graphics, and designs, enhanced by advanced barrier films and lamination techniques. The advent of cutting-edge printing technologies further elevates its potential.

Further, in contrast, the flexible plastic packaging used for liquid products packaging is adaptable, consumes fewer resources, and harnesses the finest attributes of plastic film. Currently, while flexible plastic packaging has made strides in product protection and branding with advanced barrier films, improved resistance to external factors, and superior printing technologies, the continued prominence of the rigid plastic packaging is rooted. Despite being heavier and costlier, the rigid plastic packaging remains popular due to its key advantages, such as the rigid plastic packaging provides structural integrity and protects product from any damage moisture, abrasion, and the like. These factors make the rigid plastic packaging the preferred choice despite its higher plastic consumption, weight, and expense across the supply chain.

This is because the currently used flexible plastic packaging does not provide consistent structural integrity, uniform product dispensing, and are even prone to damage during handling and transportation. Further, the currently used flexible plastic packaging lacks a user-friendly nature in overall product handling and can be easily deformed. Considering these key advantages and disadvantages of the rigid plastic packaging and the flexible plastic packaging, and in the pursuit of sustainability, plastic manufacturing companies should focus on a conscious reduction of plastic consumption while manufacturing plastic packaging to improve environmental conditions without effecting consumer convenience.

The present invention is directed to overcome one or more limitations stated above or any other limitations associated with the known arts.

### SUMMARY

In one embodiment, a liquid dispensing device is disclosed. In one example, the liquid dispensing device may include an air column configured to provide stability to the liquid dispensing device. The liquid dispensing device may further include a set of two side walls affixed to opposite sides of the air column to create a casing. The liquid dispensing device may further include a bottom wall coupled to the casing. It should be noted that the bottom wall may include an opening configured to dispense a predefined amount of the liquid. The liquid dispensing device may further include a cap attached to the bottom wall. It should be noted that the cap may include a hollow section configured to collect the predefined amount of the liquid to be dispensed from the opening.

In another embodiment, a method of dispensing liquid from liquid dispensing device is disclosed. In one example, the method may include transferring a predefined amount of the liquid from a casing into a hollow section of a cap by positioning the liquid dispensing device in an upside-down position. It should be noted that, in the upside-down position, the cap may be positioned below the casing of the liquid dispensing device. The cap may further include a top section including a lid positioned on a bottom surface, and a bottom section. The method may further include reversing the upside-down position of the liquid dispensing device to collect the predefined amount of liquid within the hollow section of the cap. The method may further include dispensing the predefined amount of liquid collected in the hollow section of the cap by uncoupling the lid coupled to the top section of the cap.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIGS. 1A and 1B illustrate an exemplary liquid dispensing device, in accordance with some embodiments of the present disclosure.

FIG. 2 illustrates an exemplary cap of a liquid dispensing device, in accordance with some embodiments of the present disclosure.

FIGS. 3A-3D is a pictorial depiction of an exemplary process of dispensing liquid from a liquid dispensing device, in accordance with some embodiment of the present disclosure.

FIG. 4 illustrates a flow chart of a method of dispensing liquid from a liquid dispensing device, in accordance with some embodiments of the present disclosure.

FIG. 5 illustrates various exemplary design structures of a liquid dispensing device, in accordance with some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

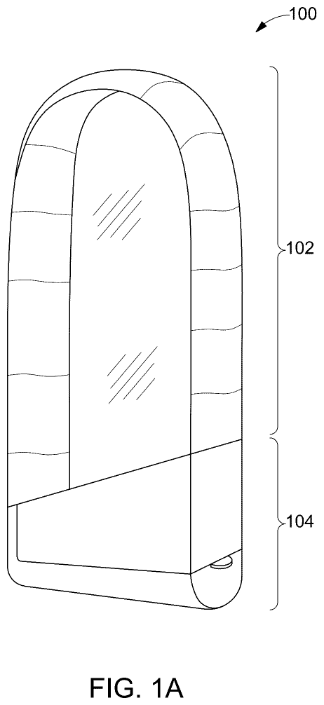

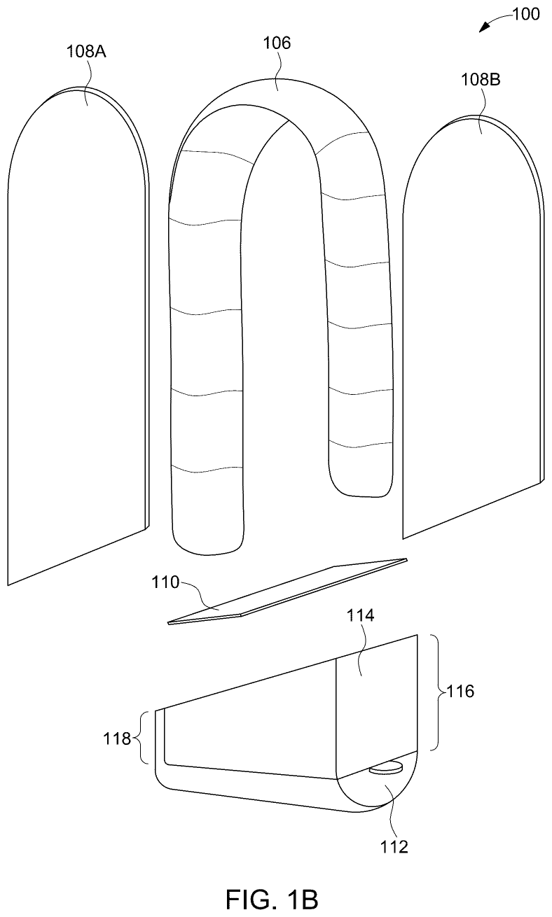

Referring now to FIGS. 1A and 1B, an exemplary liquid dispensing device 100 is illustrated, in accordance with some embodiments of a present disclosure. In FIG. 1A, an isometric view of the liquid dispensing device 100 is depicted. The liquid dispensing device 100 may be configured to dispense a predefined amount of liquid stored within the liquid dispensing device 100. Examples of the liquid stored within the liquid dispensing device may include, but are not limited to, mouth wash, shampoo, conditioner, body wash, cooking oil, hair oil, laundry detergent, dishwashing liquid, water, milk, juice, liquid medicine, and the like. As will be appreciated, the liquid dispensing device 100 may be configured to store and dispense any type of liquid. As depicted via the present FIG. 1A, the liquid dispensing device 100 may include a casing 102 and a cap 104. The casing 102 may be configured to store the liquid. It should be noted that, amount of the liquid stored within the liquid dispensing device 100 may depend upon the size and dimensions of the liquid dispensing device 100. Further, the cap 104 may be configured to dispense the predefined amount of the liquid. In order to create the casing 102, the liquid dispensing device 100 may include an air column 106, and a set of two side walls, i.e., a first wall 108A and a second wall 108B, as depicted via FIG. 1B.

In an embodiment, the air column 106 may include at least two sheets. In other words, the air column 106 may be created using the at least two sheets (for example: two plastic sheets). In an embodiment, each of the at least two sheets may be laminated together in a predefined shape. It should be noted that the at least two sheets may be limited together using an existing plastic lamination technique. Further, upon lamination, each of the at least two sheets may be inflated using air, such that each of the at least two sheets may create a sealed air column, i.e., the air column 106. Examples of the at least two sheets of the air column 106 may include, but are not limited to, a Polyvinyl chloride (PVC) plastic sheet, a bio-degradable plastic sheet, low density polyethylene, high density polyethylene, polypropylene, etc. As will be appreciated, once each of the at least two sheets are laminated and inflated using the air, the air column 106 may obtain a predefined structure, for example, a cylindrical structure, a cuboidal structure, or any other similar structure. Further, the air column 106 may be bent to get a desired shape, i.e., the predefined shape. As shown in the FIG. 1B, the predefined shape of the air column 106 may be, for example, an inverted U shape. In some embodiments, the air column 106 may be made by cutting each of the at least two sheets and then laminated together to get desired shape.

In other words, the air column 106 may be a cylindrical or cuboidal structured tube that is inflated with air and then bent to form the desired shape. In another exemplary embodiment, instead of laminating each of the at least two sheets, a hollow sheet may be inflated with air to form the air column 106. As will be appreciated, the air column 106 may be configured to provide stability to the liquid dispensing device 100. It should be noted that the air column 106 provides a flexible yet rigid support to the liquid dispensing device 100. Further, the set of two side walls 108A and 108B of the liquid dispensing device 100 may be affixed to opposite side of the air column 106 to create the casing 102. The casing 102 may be used to store the liquid to be dispensed. It should be noted that the casing 102 may correspond to a cavity or a hollow space formed by joining the air column 106 and the set of side walls 108A and 108B.

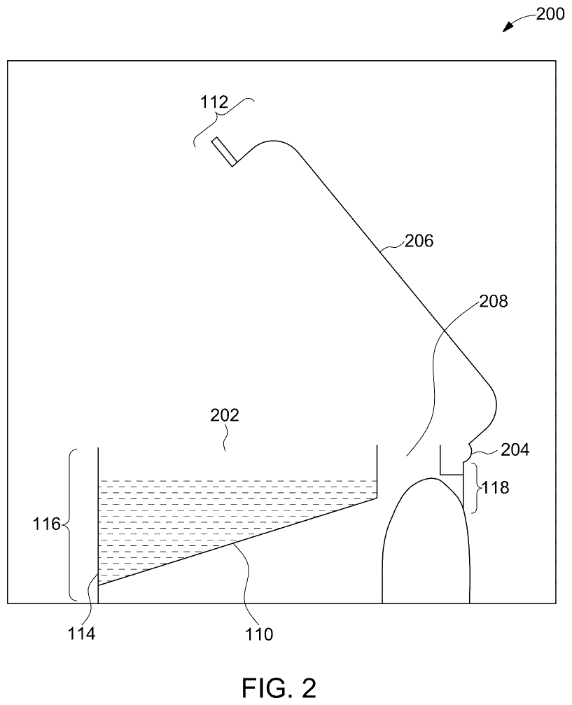

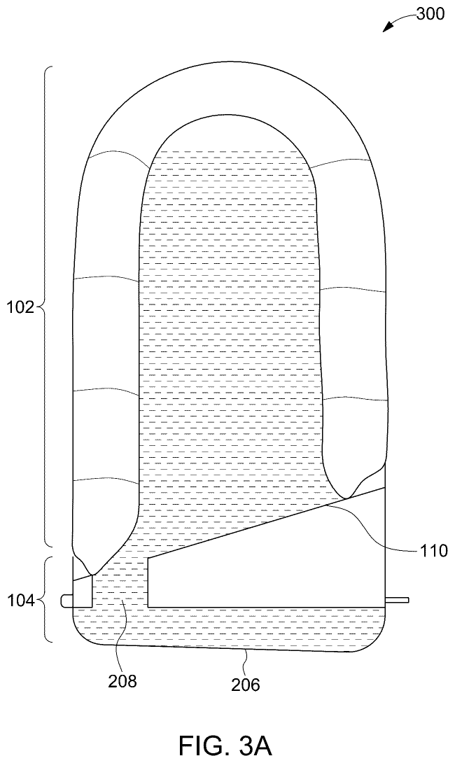

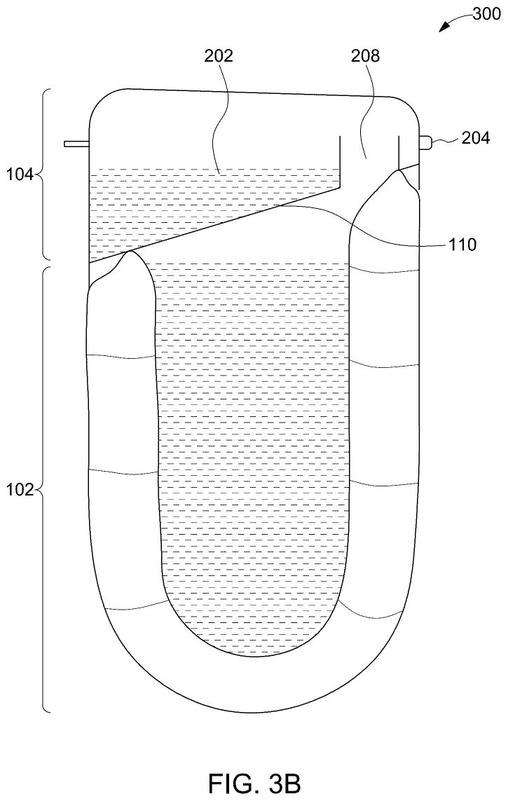

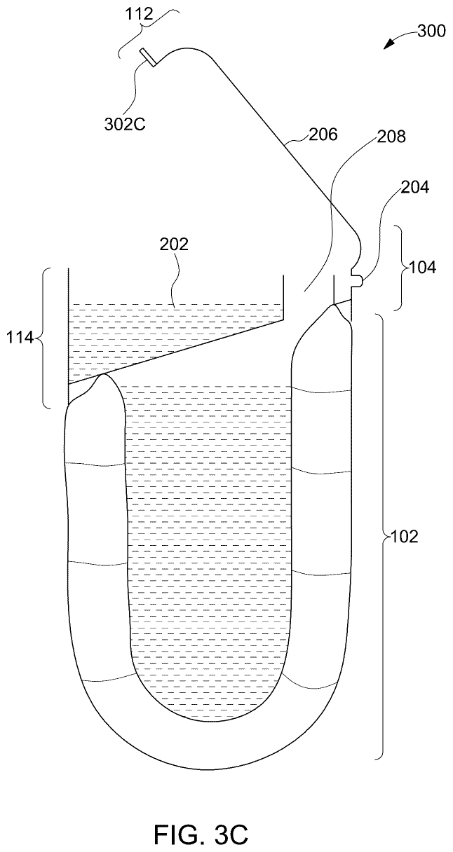

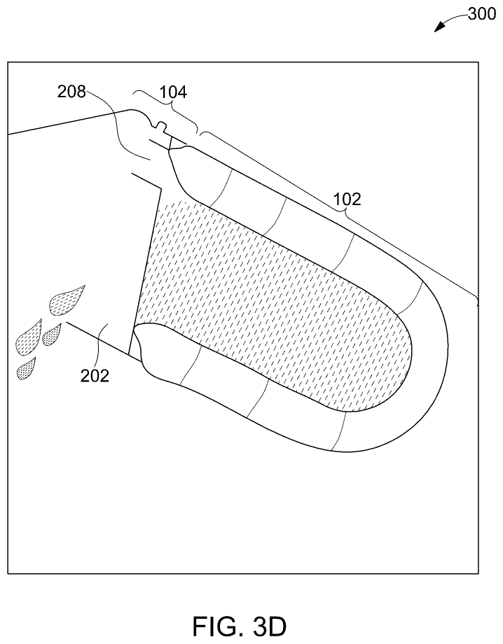

The liquid dispensing device 100 may further include a bottom wall 110. The bottom wall 110 may be coupled to the casing 102. It should be noted that, the bottom wall 110 may be coupled to the casing 102 in way such that an enclosed space is created for storing the liquid within the casing 102. The bottom wall 110 may include an opening configured to dispense the predefined amount of the liquid stored in the casing 102 of the liquid dispensing device 100. The opening of the bottom wall 110 may be a nozzle or a hole in the bottom wall 110. Further, the bottom wall 110 may be coupled to the casing 102 in an inclined position to dispense the predefined amount of the liquid as explained in detail in conjunction with FIGS. 2-3D. It should be noted that the opening of the bottom wall 110 may be present on one corner side (either left side or right side) of the bottom wall 110.

Further, the cap 104 may be attached to the bottom wall 110. The cap 104 may include a hollow section. The hollow section may be configured to collect the predefined amount of the liquid dispensed from the opening of the bottom wall 110. To dispense the predefined amount of the liquid, the cap 104 may include a top section 112 and a bottom section 114 coupled to each other via a connecting mechanism. Examples of the connecting mechanism may include, but are not limited to, a hinge mechanism, a screw-on lid mechanism, a press and seal mechanism, a twist-off lid mechanism, etc. Further, it should be noted that, in some embodiments, height of each side wall of the cap 104 may be different from each other. This is done to create the hollow section within the cap 10 for collecting the predefined amount of the liquid. For example, as depicted via the present FIG. 1B, the cap 104 may include a long side wall 116 and a short side wall 118. It should be noted that the bottom wall 110 may be coupled to the casing 102 in a way such that the opening of the bottom wall 110 lies near the short side wall 118 of the cap 104. This is further explained in detail in conjunction with FIG. 2 to FIG. 3D.

In an exemplary embodiment, the bottom section 114 of the cap 104 may include a hole attached to the opening of the bottom wall 110. The hole on the bottom section 114 may be an opening or a nozzle depending upon the opening of bottom wall 110. As will be appreciated, in one embodiment, when the opening of the bottom wall 110 is the nozzle, then the hole on the bottom section 114 may be the opening, such that the nozzle of the bottom wall 110 completely fits into the opening of the bottom section 114 of the cap 104. In another embodiment, when the opening of the bottom wall 110 is the hole, then the hole on the bottom section 114 may be the nozzle, such that the nozzle of the bottom section 114 of the cap 104 completely fits into the hole of the bottom wall 110.

The pre-defined amount of the liquid may pass through the hole on the bottom section 114 and gets collected in the hollow section of the cap 104. It should be noted that, the hole on the bottom section 114 may be present near the short side wall 118 of the cap 104 in a way such that a spacing (i.e., the hollow section) within the cap 104 is created towards the long side wall 116 of the cap upon coupling the cap 104 to the bottom wall 110. Further, the top section 112 of the cap 104 may include a lid configured to dispense the predefined amount of the liquid collected within the hollow section of the cap 104. This is further depicted and explained in detail in conjunction with FIG. 2 to FIG. 3D.

Referring now to FIG. 2, an exemplary cap 200 of the liquid dispensing device 102 is illustrated, in accordance with some embodiments of the present invention. FIG. 2 is explained in conjunction with FIG. 1A and FIG. 1B. A cap 200 may be analogous to the cap 104 of the FIG. 1A and 1B. In an embodiment, the cap 200 may be configured to attach to the casing 102 of the liquid dispensing device 100. The cap 200 may include a hollow section 202, the top section 112, and the bottom section 114. The top section 112 and the bottom section 114 of the cap 200 may be coupled to each other via a connecting mechanism (for example, a hinge mechanism 204). As will be appreciated, the hinge mechanism 204 depicted via the present FIG. 2 is just an exemplary connecting mechanism. However, any other similar connecting mechanism, for example, a screw-on lid mechanism, a press and seal mechanism, a twist-off lid mechanism, and the like, may be used for connecting the top section 112 and the bottom section 114. The top section 112 of the cap 200 may include a lid 206. The lid 206 may be coupled with the bottom section 114 via the hinge mechanism 204.

The bottom section 114 of the cap 200 may include the bottom wall 110, the long side wall 116, and the short side wall 118. The bottom wall 110, the long side wall 116 and the short side wall 118 of the bottom section 114 may be arranged in a way to create the hollow section 202 of the cap 200. The hollow section 202 may be configured to collect the predefined amount of the liquid as depicted via a dashed lines in the present FIG. 2. The predefined amount of the liquid may be dispensed from the casing 102. In an embodiment, the predefined amount of the liquid may be an amount of the liquid that the hollow section 202 may be configured to store. In other words, the amount of the liquid to be dispensed from the casing 102 may be decided based on capacity of the hollow section 202 that is configured to store the liquid. It should be noted that the bottom wall 110 may be attached to the long side wall 116 and the short side wall 118 in an inclined position as depicted in the present FIG. 2.

Further, in order to dispense the predefined amount of the liquid for storing in the hollow section 202, the bottom wall 110 of the cap 200 may include an opening, for example: a nozzle 208. As depicted in the FIG. 2, the nozzle 208 may be placed adjacent to the short side wall 118. Further, the predefined amount of the liquid may pass from the casing 102 to the hollow section 202 of the cap 200 through the nozzle 208. As will be appreciated, in some embodiments, the opening of the cap 200 may be a hole (and not the nozzle 208). In first case, when the opening of the bottom wall 110 is the nozzle 208, then the hole on the bottom section 114 may be the opening, such that the nozzle 208 of the bottom wall 110 completely fits into the hole of the bottom section 114 of the cap 200. In second case, when the opening on the bottom wall 110 is the hole, then the hole on the bottom section 114 may be a nozzle, such that the nozzle of the bottom section 114 of the cap 200 completely fits into the hole of the bottom wall 110. It should be noted that the top section 112 of the cap 200 and the bottom section 114 of the cap 200 may be connected to each other via the hinge mechanism 204 in a way such that the hinge mechanism 204 is adjacent to the short side wall 118 as depicted in the present FIG. 2.

Referring now to FIGS. 3A-3D, a pictorial depiction 300 of an exemplary process of dispensing liquid from a liquid dispensing device (e.g., the liquid dispensing device 100) is illustrated, in accordance with some embodiments of the present disclosure. FIGS. 3A-3D are explained in conjunction with FIGS. 1A-2. The liquid dispensing device 100 may be configured to store the liquid. The liquid may be stored within the casing 102. The casing 102 may be a hollow space created by coupling an air column (i.e., the air column 106) and a set of two side walls (i.e., the set of two side walls 108A and 108B). As already explained in FIG. 1B, the set of side walls 108A and 108B may be affixed to the opposite sides of the air column 106 to create the casing 102. Further, a bottom wall, i.e., the bottom wall 110 may be coupled to the casing 102. Once the bottom wall 110 is coupled, the hollow space of the casing 102 may be filled with a desired liquid though the opening on the bottom wall 110. Upon filling the desired liquid, a cap, i.e., the cap 104 may be attached to the bottom wall 110 to restrict the liquid from flowing. Further, a lid, i.e., the lid 206 present on a top section (i.e., the top section 112) may be opened to dispense the predefined amount of the liquid from the casing 102. As will be appreciated, the liquid dispensing device 100 may be reusable and can be refilled by the user as and when required.

As depicted via FIG. 3A, the liquid dispensing device 100 may be positioned in an upside-down position. In an embodiment, the upside-down position may be a default position of placing the liquid dispensing device 100. By way of an example, the default position may be a position in which the liquid dispensing device 100 is placed when the liquid dispensing device 100 is not in use. In the upside-down position, the lid 206 of the top section 112 of the cap 104 may touch a bottom surface, e.g., a top surface of a table, as depicted via the FIG. 3A. Further, while the liquid dispensing device 100 is in the upside-down position, the liquid stored in the casing 102 may flow towards the cap 104 due to an action of gravity. In the present FIG. 3A, the liquid stored within the casing 102 is depicted via dashed lines. Further, as depicted via the FIG. 3A, when the liquid dispensing device 100 is positioned in the upside-down position, the liquid may pass through the opening (for example: in this case a nozzle, i.e., the nozzle 208) of the bottom wall 110.

Further, as depicted via the FIG. 3A, in the upside-down position, the liquid may get filled in the cap 104 up to a tip level of the nozzle 208 of the bottom wall 110 due to an atmospheric pressure acting on the liquid surface. It should be noted that the atmospheric pressure is a force exerted by air on any given surface. A phenomenon of the atmospheric pressure makes sure that each time the predefined amount of the liquid passes through the nozzle 208.

Once the predefined amount of the liquid gets filled in the cap 104 as depicted via the FIG. 3A, then in order to dispense the liquid, a user of the liquid dispensing device 100 may rotate the liquid dispensing device 100 to reverse the upside-down position of the liquid dispensing device 100 as depicted via a FIG. 3B. In other words, the user of the liquid dispensing device 100 may invert the liquid dispensing device 100 as depicted in FIG. 3B. Further, when the upside-down position of the liquid dispensing device 100 is reversed, then the predefined amount of the liquid that was filled within the cap 104 (depicted via the FIG. 3A) gets collected in the hollow section 202 of the cap 104, as depicted in the present FIG. 3B. This is because, the bottom wall 110 is coupled to the casing 102 in the inclined position. It should be noted that the predefined amount of the liquid may be collected in the hollow section 202 of the cap 104 each time the upside-down position (i.e., the default position) of the liquid dispensing device 100 is reversed.

Further, since the bottom wall 110 is connected in the inclined position to create the hollow section 202, and the nozzle 208 of the bottom wall is of a predefined height, therefore the predefined amount of the liquid collected within the hollow section 202 may be prevented from returning to the casing 102 as depicted via the present FIG. 3B. In the present FIG. 3B, the predefined amount of the liquid collected within the hollow section 202 of the cap 104 and the liquid remaining within the casing 102 is depicted via dashed lines.

Further, as depicted via the present FIG. 3B, the bottom wall 110 is coupled in a way that the nozzle 208 of the bottom wall 110 is placed opposite to an inclined surface where the hollow section 202 of the cap 104 is created, as depicted in FIGS. 3A-3D. In simpler words, the nozzle 208 of the bottom wall 110 is placed near the hinge mechanism 204 (i.e., the connecting mechanism) on the short side wall 118 of the cap 104 as already explained in detail in FIGS. 1A-2. This arrangement of the nozzle 208 near the hinge mechanism 204 may ensure that only the predefined amount of the liquid that is trapped within the hollow section 202 is dispensed. Additionally, the liquid remaining in the casing 102 may be securely stored within the casing 102 without any spillage or leakage.

Further, once the predefined amount of the liquid is collected within the hollow section 202 as depicted and explained via FIG. 3B, then the user of the liquid dispensing device 100 may open the lid 206 of the top section 112 of the cap 104. As depicted via the present FIG. 3C, the lid 206 may be opened via an attachment 302C. It should be noted that the attachment 302C is an exemplary depiction. However, the lid 206 of the cap 104 may be opened via a push button, or by completely detaching the top section 112 from the bottom section 114 based on a type of the connecting mechanism. Since in the present FIG. 3C, the connecting mechanism is the hinge mechanism 204, therefore the lid 206 is opened using the attachment 302C. It should be noted that the lid 206 may be uncoupled from the bottom section 114 of the cap 104 depending upon the type of the connecting mechanism. Examples of the connecting mechanism other than the hinge mechanism 204 may include but are not limited to, a screw-on lid mechanism, a press and seal mechanism, a twist-off lid mechanism, and the like.

Further, upon uncoupling the lid 206, the user of the liquid dispensing device 100 may tilt the liquid dispensing device 100 to dispense the predefined amount of the liquid collected within the hollow section 202 of the cap 104 as depicted via the present FIG. 3D. The liquid dispensing device 100 may be rotated in a direction opposite to the nozzle 208 to dispense the predefined amount of the liquid. It should be noted that the liquid dispensing device 100 is tilted by a predefined angle so as not to spill the liquid remaining in the casing 102 of the liquid dispensing device 100. This innovative design of the cap 104 and orientation of the liquid dispensing device 100 may enable precise dosing of the liquid, ensuring user convenience. Moreover, this combination of the design of the cap 104 and the orientation may also enhance overall user experience, making the liquid dispensing device 100 an eco-friendly and user-friendly solution for liquid products across various industries.

By way of an example, consider a scenario where the liquid dispensing device 100 may correspond to a mouth wash bottle containing mouth wash (i.e., the liquid). In this scenario, initially the mouth wash bottle may be placed in the upside-down position, i.e., the default position, as depicted via the FIG. 3A. In the upside-down position, the mouth wash stored in the casing 102 of the mouth wash bottle may flow towards the cap 104 due to the action of gravity. Further, while flowing, the mouth wash may pass through the nozzle 208 of the bottom wall 110 and may get filled in the cap 104 up to the tip level of the nozzle 208. It should be noted that this may happen each time the mouth wash bottle is placed in the upside-down position, i.e., the default position. Further, once the predefined amount of the mouth wash gets filled in the cap 104 as depicted via the FIG. 3A, then when the user of the mouth wash bottle may pick up the mouth wash bottle to dispense the predefined amount of the mouth wash, then the user may initially rotate the mouth wash bottle to reverse the upside-down position of the mouth wash bottle as depicted via the FIG. 3B.

Further, when the user may reverse the upside-down position, then the predefined amount of the mouth wash filled within the cap 104 gets collected in the hollow section 202 of the cap. The predefined amount of the mouth wash collected in the hollow section 202 is depicted via the dashed lines. Upon reversing the upside-down position, the user may open the lid 206 of the mouth wash bottle to dispense the predefined amount of the mouth wash collected in the hollow section 202 of the cap 104 as depicted via the FIG. 3C. To dispense the predefined amount of the mouth wash, the user may tilt the mouth wash bottle to the predefined angle (for example: 45 degree) such that the predefined amount of the mouth wash that is collected in the hollow section 202 is only dispensed as depicted via the FIG. 3D. It should be noted that, a unique structuring, design, and arrangement of the cap 104 and the casing 102 ensure that remaining mouth wash (depicted via the dashed lines) stored within the casing 102 of the mouth wash bottle do not spill while dispensing the predefined amount of the mouth wash.

An innovative design of the liquid dispensing device 100 depicted via the FIG. 1A-3D, not only enhances durability of the liquid dispensing device 100 with minimum use of plastic, but also contributes to user friendly nature. By incorporating the air column 106 with the predefined shape, i.e., the inverted-U shape, the liquid dispensing device 100 may achieve an effective balance between structural integrity and efficient reduction in plastic usage. The air column 106 used in the liquid dispensing device 100 may differ from conventional packaging techniques, offering a lightweight, yet highly reliable solution that promotes sustainability and improves overall user experience.

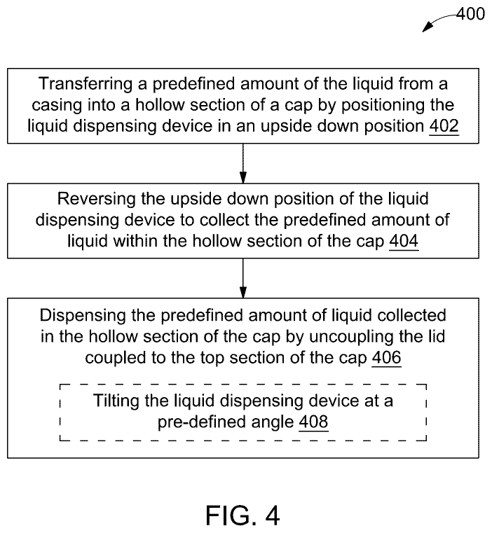

Referring now to FIG. 4, a method 400 of dispensing liquid from a liquid dispensing device (for example, the liquid dispensing device 100) is illustrated via a flow chart, in accordance with some embodiments of the present disclosure. FIG. 4 is explained in conjunction with FIGS. 1A-3. At step 402, a predefined amount of the liquid may be transferred from a casing into a hollow section of a cap by positioning the liquid dispensing device in an upside-down position. The upside-down position of the liquid dispensing device is depicted via FIG. 3A. The upside-down position of the liquid dispensing device may correspond to a default position in which the liquid dispensing device is placed when not in use. Further, the transferring of the predefined amount of the liquid from the casing, i.e., the casing 102 to the hollow section, i.e., the hollow section is depicted and explained via FIG. 3A and 3B. With reference to FIG. 1B, the casing may be a hollow space formed by joining the air column 106 and the set of side walls 108A and 108B. In addition, the bottom wall 110 may be attached to the casing 102 to create the enclosed space. Further, in the upside-down position, a cap (i.e., the cap 104) may be positioned below the casing 102 of the liquid dispensing device 100, as depicted via the FIG. 3A. Further, the cap 104 may include a top section, i.e., the top section 112 and a bottom section, i.e., the bottom section 114. The top section may include a lid, i.e., the lid 202 positioned on a bottom surface (e.g., the top surface of a slab or a table). This has been depicted and already explained in detail in conjunction with FIG. 3A.

Once the predefined amount of the liquid gets transferred, then at step 404, the upside-down position of the liquid dispensing device may be reversed. The upside-down position of the liquid dispensing device may be reversed to collect the predefined amount of the liquid within the hollow section of the cap. In other words, the liquid dispensing device may be inverted to collect the predefined amount of the liquid in the hollow section. This has been depicted and already explained in detail in conjunction with FIG. 3B. Further, at step 406, the predefined amount of the liquid collected in the hollow section of the cap may be dispensed by uncoupling the lid coupled to the top section of the cap. Once the lid is uncoupled, then at step 408, the liquid dispensing device may be tilted at a predefined angle to dispense the predefined amount of the liquid from the hollow section of the cap. A technique to uncouple and tilt the liquid dispensing device to dispense the predefined amount of the liquid has been depicted and already explained in detail in conjunction with FIGS. 3C and 3D.

By way of an example, consider a scenario where the liquid dispensing device (i.e., the liquid dispensing device 100) may correspond to a shampoo bottle containing shampoo (i.e., the liquid). In this scenario, initially the shampoo bottle may be placed in its default position, i.e., the upside-down position. In the default position, the shampoo stored in a casing (i.e., the casing 102) of the shampoo bottle may flow towards a cap (i.e., the cap 104). Further, when the user of the shampoo bottle may want to dispense a predefined amount of shampoo stored in the shampoo bottle. Then, for this, the user may reverse the default position of the shampoo bottle by rotating the shampoo bottle. In other words, the user may invert the shampoo bottle to reverse the upside-side down position of the shampoo bottle.

Further, when the user may reverse the upside-down position, then the predefined amount of the shampoo gets collected in the hollow section of the cap. Upon reversing the upside-down position, the user may open a lid, i.e., the lid 206 to dispense the predefined amount of the shampoo collected in the hollow section of the cap. To dispense the predefined amount of the shampoo, the user may tilt the shampoo bottle to a predefined angle (for example: 50 degree) such that the predefined amount of the shampoo that is collected in the hollow section is only dispensed. It should be noted that the unique structuring, design, and arrangement of the cap and the casing ensure that remaining shampoo stored within the casing of the shampoo bottle do not spill while dispensing the predefined amount of the shampoo. This complete process of dispensing the predefined amount of the liquid from the liquid dispensing device 100 has been already explained in detail in the above FIGS. 1A-3D.

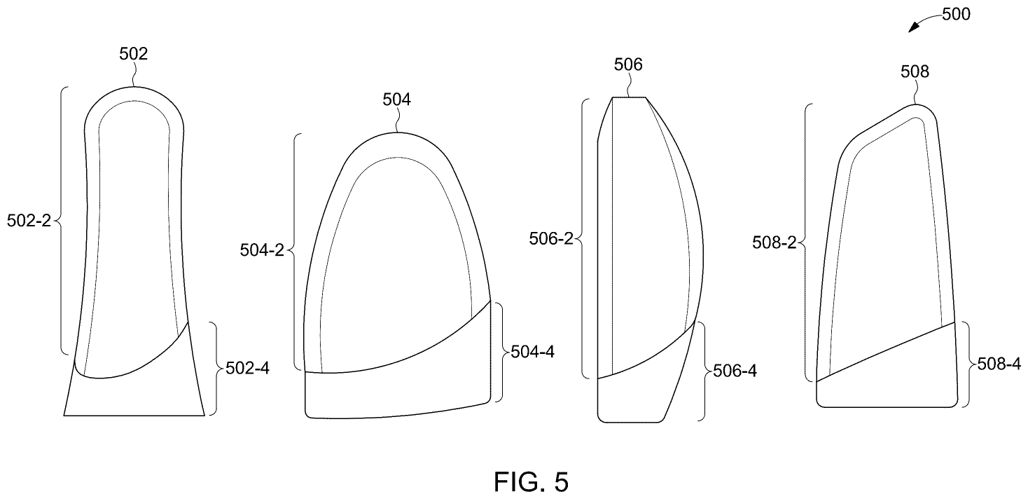

Referring now to FIG. 5, various exemplary design structures 500 of a liquid dispensing device (for example: the liquid dispensing device 100) are illustrated, in accordance with some embodiments of the present disclosure. FIG. 5 is explained in conjunction with FIGS. 1A-4. In an embodiment, each of the liquid dispensing devices 502-508 may be analogous to the liquid dispensing device 100. The liquid dispensing device 100 may be designed and manufactured in a plurality of sizes and shapes as depicted in the present FIG. 5. The liquid dispensing devices 502-508 with different design structure may be manufactured by altering dimensions and shape of an air column (i.e., the air column 106) and a set of two side walls (i.e., the set of two side walls 108A and 108B) configured to create a casing (i.e., the casing 102), a bottom wall (i.e., the bottom wall 110) attached to the casing, and a cap (i.e., the cap 104).

As depicted via the present FIG. 5, the liquid dispensing device 502 may include a casing 502-2 and a cap 502-4. With reference to the above FIGS. 1A-4, the casing 502-2 may correspond to the casing 102. Similarly, the cap 502-4 may correspond to the cap 104. Further, the liquid dispensing device 504 may include a casing 504-2 and a cap 504-4. The casing 504-2 may correspond to the casing 102. In addition, the cap 504-4 may correspond to the cap 104. Similarly, the liquid dispensing devices 506 and 508 may include casings 506-2 and 508-2 and cap's 506-4 and 508-4, respectively. Further, each of the casings 506-2 and 508-2 may correspond to the casing 102. In addition, each of the cap's 506-2 and 508-2 may correspond to the cap 102.

It should be noted that liquid dispensing devices 502-508 may be used for storing any type of liquid. Moreover, each of the liquid dispensing devices 502-508 may be reusable. For example, the user of the liquid dispensing device 502 may refill the casing 502-2 with a required liquid based on his requirement. This may be done by detaching the cap 502-4 from the casing 502-2. It should be noted that the design structure of the liquid dispensing device 100 is not limited to the design structures shown via the liquid dispensing devices 502-508 in the present FIG. 5. Moreover, any number of liquid dispensing device with different dimensions and shapes may be created adjusting dimensions and shaped of components (e.g., the air column, the set of two side walls, the bottom wall, the cap, etc.) used for manufacturing liquid dispensing device.

Various embodiments provide a liquid dispensing device and a method of dispensing liquid thereof. The disclosed liquid dispensing device may include an air column configured to provide stability to the liquid dispensing device. Further, the disclosed liquid dispensing device may include a set of two side walls affixed to opposite sides of the air column to create a casing. In addition, the disclosed liquid dispensing device may include a bottom wall coupled to the casing. The bottom wall may include an opening configured to dispense a predefined amount of the liquid. Furthermore, the disclosed liquid dispensing device may include a cap attached to the bottom wall. The cap may include a hollow section configured to collect the predefined amount of the liquid to be dispensed from the opening.

Thus, the present disclosure may overcome drawbacks of traditional conventional flexible and rigid packaging used for liquid products. The present disclosure includes a customizable design of a liquid dispensing device that may cater to diverse needs of users. The disclosed liquid dispensing device may provide user convenience by dispensing uniform amount of liquid easily and conveniently. In other words, the disclosed liquid dispensing device may incorporate an ingenious cap design and specific orientation of the liquid dispensing device that may ensure precise dosing and controlled dispensing of liquid content. The disclosed liquid dispensing device may provide structural integrity with minimum plastic use. For this the disclosed liquid dispensing device may use an air column. The air column may play a vital role in maintaining stability of the liquid dispensing device and prevent it from collapsing. Additionally, the air column may resist deformation during transportation, storage, and usage, ensuring the disclosed liquid dispensing device retains its original shape and protects the stored liquid content from potential damage. Moreover, by incorporating the air column and by optimizing the use of plastic material, the disclosed liquid dispensing device may reduce plastic consumption significantly as compared to conventional packaging, hence improving environmental conditions.

Further, manufacturing process of the disclosed liquid dispensing device may have been significantly simplified as compared to manufacturing of conventional packaging with the use a lamination technique for production. For this, at least two sheets are laminated and then inflated by air to create the air column. This lamination technique may ensure a strong bond between the at least two sheets, providing excellent structural integrity to the disclosed liquid dispensing device. Further, the use of the lamination technique may eliminate the need for complex assembly processes or additional components, streamlining the manufacturing process workflow, and reducing production time. This not only results in cost savings but also contributes to a more sustainable approach by minimizing waste and resource consumption during the production.

Further, the unique cap design of the disclosed liquid dispensing device ensures that each time the liquid dispensing device is used, an equal amount of liquid is dispensed in every use without use of any external pressure. In addition, the unique cap design prevents wastage or spillage of the liquid content within the liquid dispensing device during usage. Additionally, the disclosed liquid dispensing device may be manufactured in a variety of designs and shapes to accommodate requirements of all business entities and variety of liquid contents. In addition, the structure of the disclosed liquid dispensing device facilitates branding (e.g., visual graphics) of liquid products as per the requirements of business entities.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A liquid dispensing device comprising:
an air column configured to provide stability to the liquid dispensing device;
a set of two side walls affixed to opposite sides of the air column to create a casing;
a bottom wall coupled to the casing, wherein the bottom wall comprises;
an opening configured to dispense a predefined amount of the liquid; and
a cap attached to the bottom wall, wherein the cap comprises a hollow section configured to collect the predefined amount of the liquid to be dispensed from the opening.

2. The liquid dispensing device of claim 1, wherein the air column comprises at least two sheets, wherein each of the at least two sheets are laminated together in a predefined shape and inflated using air.

3. The liquid dispensing device of claim 1, wherein the bottom wall is coupled to the casing in an inclined position to dispense the predefined amount of the liquid.

4. The liquid dispensing device of claim 1, wherein the cap comprises:
a top section and a bottom section coupled to each other via a connecting mechanism.

5. The liquid dispensing device of claim 1, wherein the bottom section of the cap comprises a hole attached to the opening of the bottom wall, wherein the predefined amount of the liquid passes through the hole and gets collected in the hollow section.

6. The liquid dispensing device of claim 1, wherein the top section of the cap comprises:
a lid configured to dispense the predefined amount of liquid collected within the hollow section of the cap.

7. A method of dispensing liquid from a liquid dispensing device, the method comprising:
transferring a predefined amount of the liquid from a casing into a hollow section of a cap by positioning the liquid dispensing device in an upside-down position, wherein, in the upside-down position, the cap is positioned below the casing of the liquid dispensing device, and wherein the cap comprises a top section comprising a lid positioned on a bottom surface, and a bottom section;
reversing the upside-down position of the liquid dispensing device to collect the predefined amount of liquid within the hollow section of the cap; and
dispensing the predefined amount of liquid collected in the hollow section of the cap by uncoupling the lid coupled to the top section of the cap.

8. The method of claim 7, wherein dispensing the predefined amount of liquid comprises tilting the liquid dispensing device at a pre-defined angle.
